(19) United States
(12) Patent Application Publication
(10) Pub. No.: US 2024/0430482 A1
(43) Pub. Date: Dec. 26, 2024

(54) METHOD, APPARATUS, AND MEDIUM FOR VISUAL DATA PROCESSING

(71) Applicants: Beijing Bytedance Network Technology Co., Ltd., Beijing (CN); Bytedance Inc., Los Angeles, CA (US)

(72) Inventors: Semih ESENLIK, Los Angeles, CA (US); Yaojun Wu, Beijing (CN); Zhaobin Zhang, Los Angeles, CA (US); Yue Li, Los Angeles, CA (US); Kai Zhang, Los Angeles, CA (US); Li Zhang, Los Angeles, CA (US)

(21) Appl. No.: 18/823,504

(22) Filed: Sep. 3, 2024

Related U.S. Application Data
(63) Continuation of application No. PCT/CN2023/079553, filed on Mar. 3, 2023.

(30) Foreign Application Priority Data
Mar. 3, 2022 (WO) PCT/CN2022/079015

(51) Int. Cl. H04N 19/61; H04N 19/124; H04N 19/132; H04N 19/42; H04N 19/463; H04N 19/91

(52) U.S. Cl. CPC H04N 19/61; H04N 19/124; H04N 19/132; H04N 19/42; H04N 19/463; H04N 19/91

(57) ABSTRACT

Embodiments of the present disclosure provide a solution for visual data processing. A method for visual data processing is proposed. The method comprises: obtaining, for a conversion between visual data and a bitstream of the visual data, an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; and performing, for the conversion, a synthesis transform on the intermediate representation, wherein the quantized latent representation is generated based on applying a first neural network to the visual data.

### CROSS REFERENCE

This application is a continuation of International Application No. PCT/CN2023/079553, filed on Mar. 3, 2023, which claims the benefit of International Application No. PCT/CN2022/079015 filed on Mar. 3, 2022. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality of neural network-based image/video coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data, an intermediate representation of the visual data, the intermediate representation being different from a quantized latent representation of the visual data and being generated based on at least one of the following: at least one parameter, at least a part of the quantization, a prediction of the at least a part of the quantization, or a difference between the prediction and the at least a part of the quantization; and performing, for the conversion, a synthesis transform on the intermediate representation, wherein the quantized latent representation is generated based on applying a first neural network to the visual data.

According to the method in accordance with the first aspect of the present disclosure, an intermediate representation different from a quantized latent representation of the visual data is generated and used for the synthesis transform. Compared with the conventional solution where the quantized latent representation is directly used for the synthesis transform, the proposed method can at least partially eliminate artifacts caused by the conventional conversion process, and thus the reconstructed image may be more visually pleasing. Thereby, the proposed method can advantageously improve the coding quality.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining an intermediate representation of the visual data, the intermediate representation being different from a quantized latent representation of the visual data and being generated based on at least one of the following: at least one parameter, at least a part of the quantization, a prediction of the at least a part of the quantization, or a difference between the prediction and the at least a part of the quantization; and generating the bitstream based on a synthesis transform on the intermediate representation, wherein the quantized latent representation is generated based on applying a first neural network to the visual data.

In a fifth aspect, a method for storing a bitstream of visual data is proposed. The method comprises: obtaining an intermediate representation of the visual data, the intermediate representation being different from a quantized latent representation of the visual data and being generated based on at least one of the following: at least one parameter, at least a part of the quantization, a prediction of the at least a part of the quantization, or a difference between the prediction and the at least a part of the quantization; generating the bitstream based on a synthesis transform on the intermediate representation; and storing the bitstream in a non-transitory computer-readable recording medium, wherein the quantized latent representation is generated based on applying a first neural network to the visual data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates an alternative encoding process;

FIG. 9 illustrates an alternative decoding process;

FIG. 10 illustrates two possible implementations of the entropy coding and quantization processes;

FIG. 11 illustrates corresponding decoder implementations for the encoder implementations;

FIG. 12 illustrates an example decoder implementation in accordance with some embodiments of the present disclosure;

FIG. 13 illustrates another example decoder implementation in accordance with some embodiments of the present disclosure;

FIG. 14 illustrates a further example decoder implementation in accordance with some embodiments of the present disclosure;

FIG. 15 illustrates an example visual data decoding process according to some embodiments of the present disclosure;

FIG. 16 illustrates another example visual data decoding process according to some embodiments of the present disclosure;

FIG. 17 illustrates a flowchart of a method for visual data processing in accordance with some embodiments of the present disclosure;

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

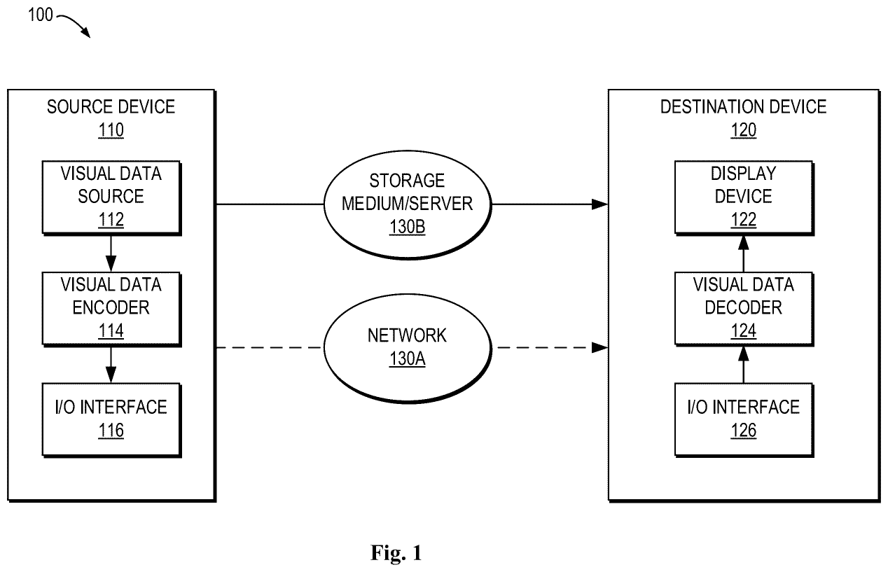

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

A neural network based image and video compression method comprising an auto-regressive subnetwork, wherein the latent representation of the image is first processed by an autoregressive network, then it is modified according to an additive or multiplicative term, and finally processed by a synthesis network to obtain the reconstructed picture.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1. Pixel Probability Modeling

According to Shannon's information theory, the optimal method for lossless coding can reach the minimal coding rate-log₂p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) \text{} = \text{} p ( {x}_{1} ) p ( {x}_{2} \vert \text{} {x}_{1} ) … p \text{} ( {x}_{i} \vert {x}_{i - k} , … , {x}_{i - 1} ) \text{} … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration. Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. In [7], the pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Experiments are performed on the binarized MNIST dataset. In an existing design, NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks. Designing advanced neural networks plays an important role in improving pixel probability modeling. In an existing design, multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later in an existing design. Several different neural networks are studied, including RNNs and CNNs namely PixelRNN and PixelCNN, respectively. In PixelRNN, two variants of LSTM, called row LSTM and diagonal BILSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In an existing design, Gated PixelCNN is proposed to improve the PixelCNN, and achieves comparable performance with PixelRNN but with much less complexity. In an existing design, PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In an existing design, PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, it may be estimated that

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2. Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

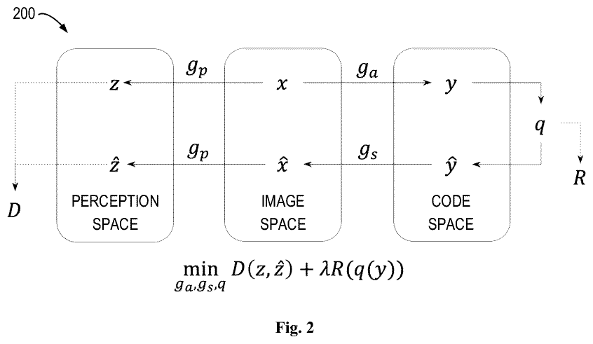

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. It only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area. The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and A is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, Toderici et al. propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. then proposed an improved version by upgrading the encoder with a neural network similar to PixelRNN to compress the binary codes. The performance is reportedly better than JPEG on Kodak image dataset using MS-SSIM evaluation metric. Johnston et al. further improve the RNN-based solution by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Covell et al. support spatially adaptive bitrates by training stop-code tolerant RNNs.

Ballé et al. proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in an existing design. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. further exploit the structures in the residue space by introducing an autoregressive model to estimate both the standard deviation and the mean. In an existing design, Z. Cheng et al. use Gaussian mixture model to further remove redundancy in the residue. The reported performance is on par with VVC on the Kodak image set using PSNR as evaluation metric.

### 2.3.3. Hyper Prior Model

In the transform coding approach to image compression, the encoder subnetwork (section 2.3.2) transforms the image vector x using a parametric analysis transform gₐ(x, Øg) into a latent representation y, which is then quantized to form ŷ. Because ŷ is discrete-valued, it can be losslessly compressed using entropy coding techniques such as arithmetic coding and transmitted as a sequence of bits.

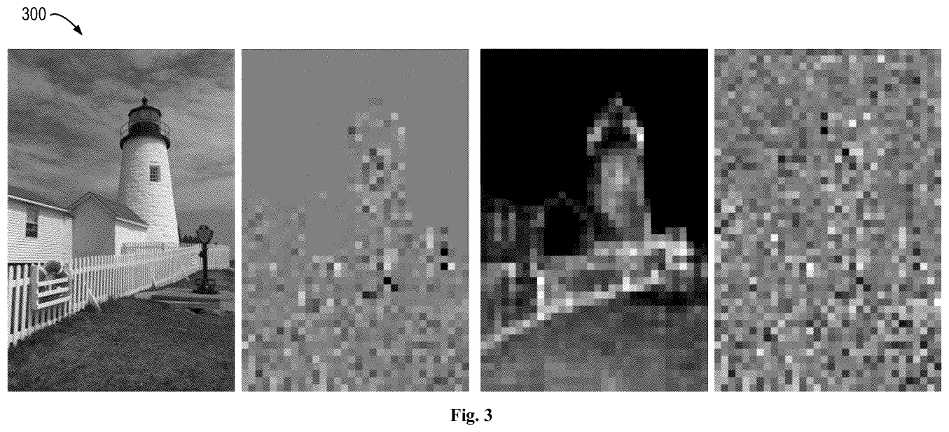

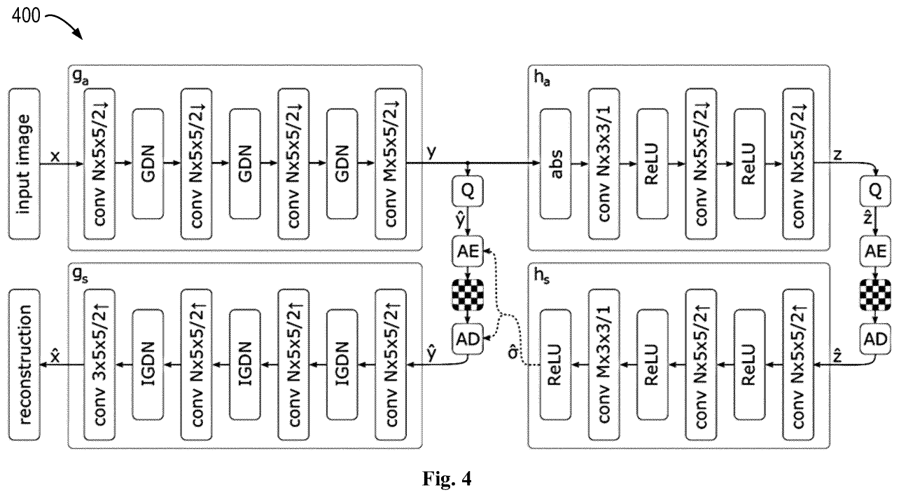

As evident from the middle left and middle right image of FIG. 3, there are significant spatial dependencies among the elements of ŷ. Notably, their scales (middle right image) appear to be coupled spatially. In an existing design, an additional set of random variables 2 are introduced to capture the spatial dependencies and to further reduce the redundancies. In this case the image compression network is depicted in FIG. 4.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 3 correspond to the quantized latent when hyper encoder/decoder are used. Compared to middle right image, the spatial redundancies are significantly reduced, as the samples of the quantized latent are less correlated. FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations σ of the latent. The rightmost image in FIG. 3 shows latents y after the hyper prior (hyper encoder and decoder) network is introduced.

FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4. Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

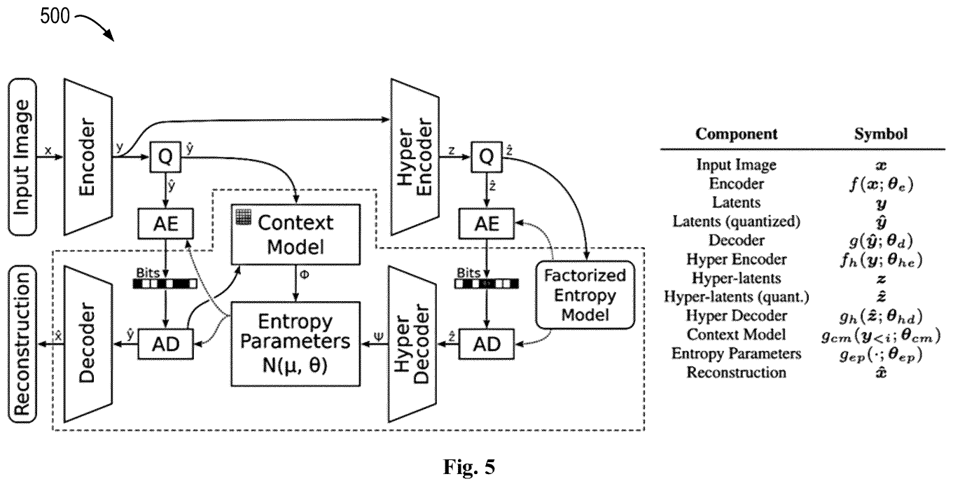

An existing design utilizes a joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean u and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 5 illustrates a block diagram of a combined model. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically the latent samples are modeled as gaussian distribution or gaussian mixture models (not limited to). In an existing design, and according to the FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5. The Encoding Process Using Joint Auto-Regressive Hyper Prior Model

The FIG. 5. corresponds to the state of the art compression method. In this section and the next, the encoding and decoding processes will be described separately.

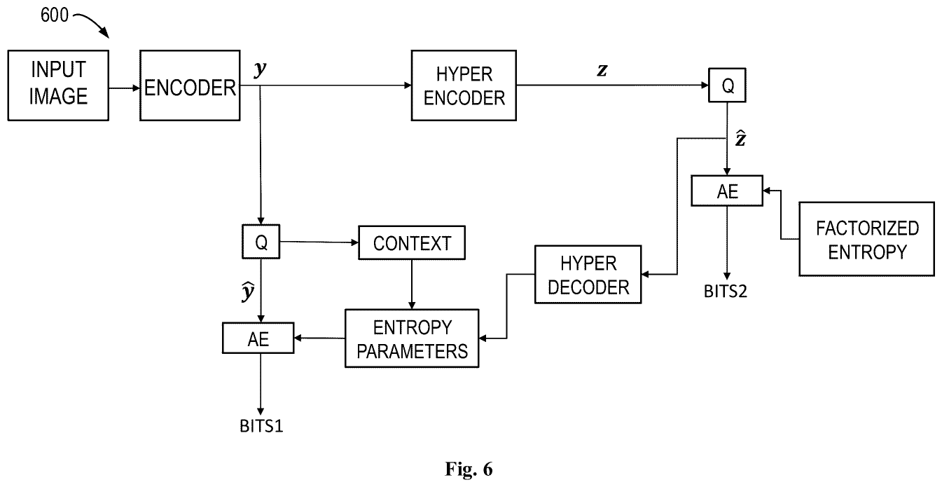

The FIG. 6 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order. The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i, j, k] or ŷ[i,j] depending on the dimensions of the matrix. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1). Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.6. The Decoding Process Using Joint Auto-Regressive Hyper Prior Model

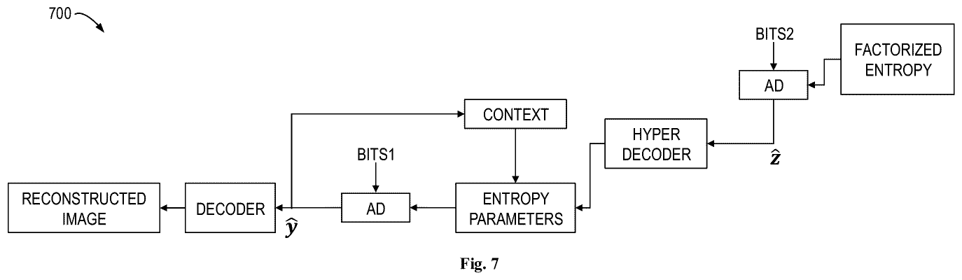

The FIG. 7 depicts the decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.3.7. Alternative Encoding Process Using Joint Auto-Regressive Hyper Prior Model

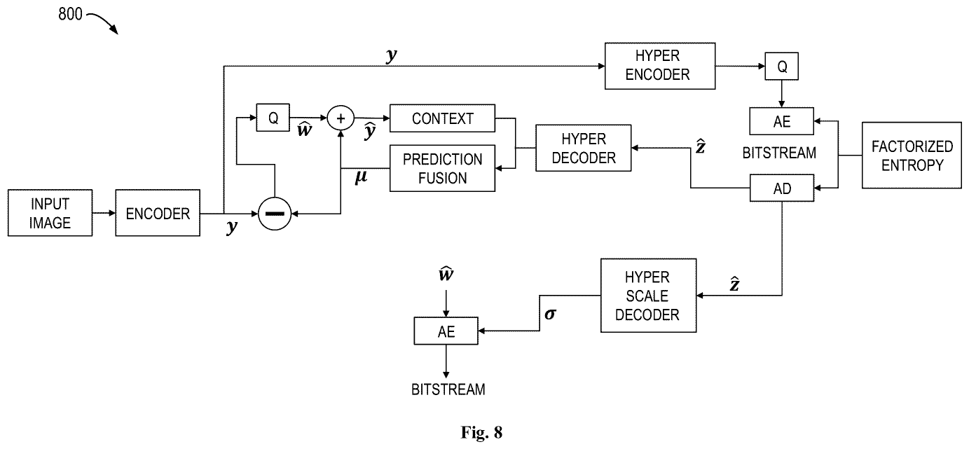

An alternative implementation of the encoder can be depicted in the FIG. 8. The difference to the encoder depicted in FIG. 6 is how the quantized latent is obtained and what is encoded into the bitstream.

In FIG. 6, samples of the quantized latent ŷ are obtained by quantizing the latent y. furthermore the samples of ŷ are included in the bitstream by the entropy encoder (or arithmetic encoder). It is noted that arithmetic encoder is a special case of entropy encoder.

In FIG. 8, the quantized latent ŷ is obtained according to the mean value μ and the quantized residual latent ŵ (e.g. by summing them up). The mean value is obtained recursively by using the previously obtained samples of ŷ. The quantized residual latent ŵ obtained by subtracting the μ from latent y and then quantizing the result. Finally the arithmetic encoder module (AE) encodes the quantized residual latent into the bitstream.

### 2.3.8. Alternative Decoding Process Using Joint Auto-Regressive Hyper Prior Model

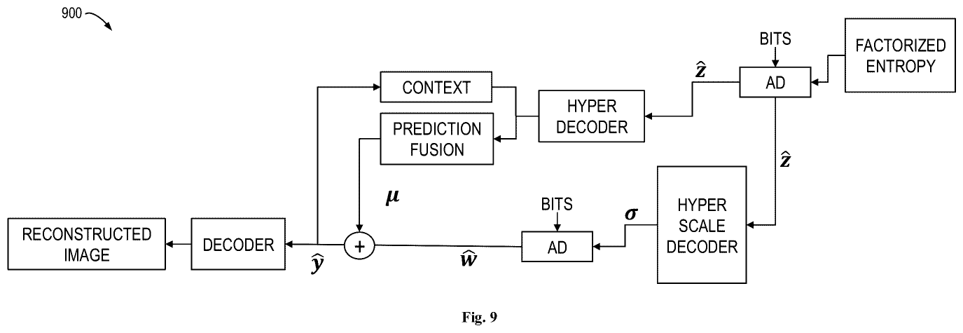

An alternative implementation of the decoder can be depicted in the FIG. 9. The difference to the decoder depicted in FIG. 7 is how the quantized latent is obtained and what is obtained from the bitstream.

In FIG. 9, the quantized residual latent ŵ is obtained from the bitstream by arithmetic decoder (AD, or entropy decoder). And quantized latent ŷ is obtained using mean value μ and the quantized residual ŵ(e.g. by summing them up). The mean value is obtained by the prediction module using the previously obtained samples of ŷ.

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1. Low-Latency

Chen et al. are the first to propose a video compression scheme with trained neural networks. They first split the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method. Chen et al. propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Lu et al. propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

J. Lin et al. propose an extended end-to-end neural network-based video compression framework. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than H.265 by a noticeable margin in terms of both PSNR and MS-SSIM.

Eirikur et al. propose scale-space flow to replace commonly used optical flow by adding a scale parameter. It is reportedly achieving better performance than H.264.

Z. Hu et al. propose a multi-resolution representation for optical flows. Concretely, the motion estimation network produces multiple optical flows with different resolutions and let the network to learn which one to choose under the loss function. The performance is slightly improved and better than H.265.

### 2.4.2. Random Access

Wu et al. propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. propose a method for interpolation-based video compression, wherein the interpolation model combines motion information compression and image synthesis, and the same auto-encoder is used for image and residual.

Amirhossein et al. propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5. Preliminaries

Almost all the natural image/video is in digital format. A grayscale digital image can be represented by x∈ [symbol] ^{m×n}, where D is the set of values of a pixel, m is the image height and n is the image width. For example, [symbol] ={0, 1, 2, . . . , 255} is a common setting and in this case | [symbol] |=256=28, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=28, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$P S N R = 10 \times {log}_{10} \frac{{( max ( ) )}^{2}}{M S E} \qquad ( 5 )$$

where max ( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.5.1. Quantization and Entropy Coding

The terms quantization and entropy coding can be defined as follows:

Quantization, in mathematics and digital signal processing, is the process of mapping input values from a large set (often a continuous set) to output values in a (countable) smaller set, often with a finite number of elements. Rounding and truncation are typical examples of quantization processes. Quantization is involved to some degree in nearly all digital signal processing, as the process of representing a signal in digital form ordinarily involves rounding. Quantization also forms the core of essentially all lossy compression algorithms.

The equation of quantization can be as follows:

$$\hat{y} = round ( \frac{y}{Δ} ) \qquad ( eq . 1 )$$

Wherein the ŷ is the quantized value, y is the sample to be quantized and Δ is the quantization step size. For example according to the equation 1 above, if the quantization step size is increased, the quantized value ŷ will get smaller and less bits will be needed to encode the quantized sample. In other words the increased quantization step size results in a coarser quantization. On the other hand a smaller Δ (which is usually a positive number) results in a finer quantization and higher number of bits to encode ŷ into the bitstream. An entropy coding is a general lossless data compression method that encodes symbols by using an amount of bits inversely proportional to the probability of the symbols. A term used to denote some compression algorithms, which works based on the probability distribution of source symbols. Huffman coding and arithmetic coding are two typical algorithms of this kind. In order to perform entropy coding, the statistical properties (e.g. probability distribution) of the symbols must be known.

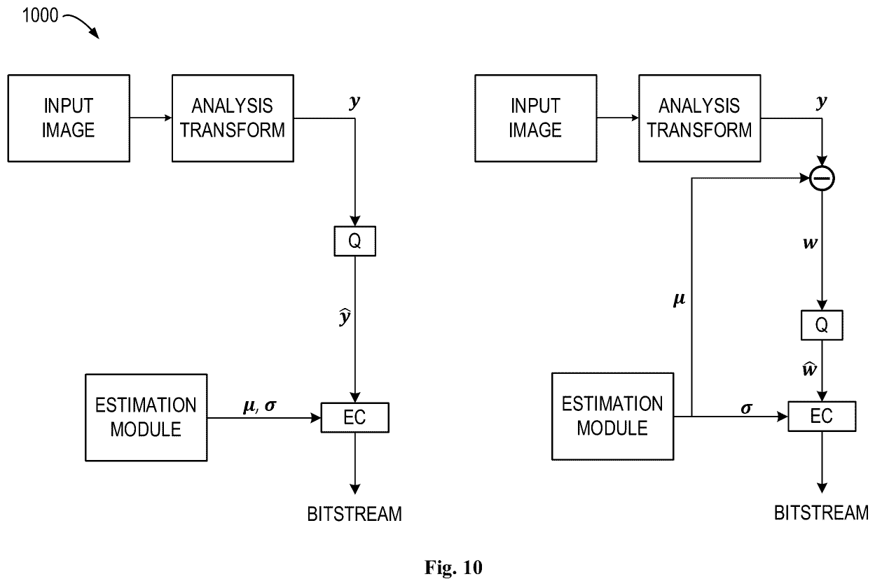

FIG. 10 illustrates two possible implementations of the entropy coding and quantization processes in NN based image compression. Encoder perspectives are depicted.

In FIG. 10, two possible implementations of the encoder of an NN based image compression method are depicted. The encoder of an NN based image compression method is composed of 4 modules. The first module is the analysis transform. The analysis transform transforms the input image into latent representation y. The transformed representation y is usually easier to compress than the input image, since the analysis transform is designed to eliminate redundancies in the input image signal. The second module is the Estimation Module, which estimates the statistical properties of the latent representation. The statistical properties might include a mean value (denoted by μ), a variance (denoted σ) or higher order moments. The third module is the quantization module, which converts the continuous latent representation signal into quantized discrete values. Finally the fourth module is the entropy coding (denoted by EC), which converts the quantized symbol values into bitstream using the statistical properties generated by the estimation module.

Two slightly different implementation alternatives exist for the encoder, based on how the mean value μ is used. In the first implementation the entropy coding module receives the mean value and the other statistics (like the variance σ) as input, and uses them to encode the quantized latent symbols ŷ into bitstream. In the second implementation alternative the mean value is first subtracted from latent symbols y to obtain the residual samples w. Then the residual samples are quantized by the quantization module to obtain quantized residual samples ŵ. The entropy coding module converts the quantized residual samples into bitstream using the statistical information generated by the estimation module. The statistical information might include for example variance σ.

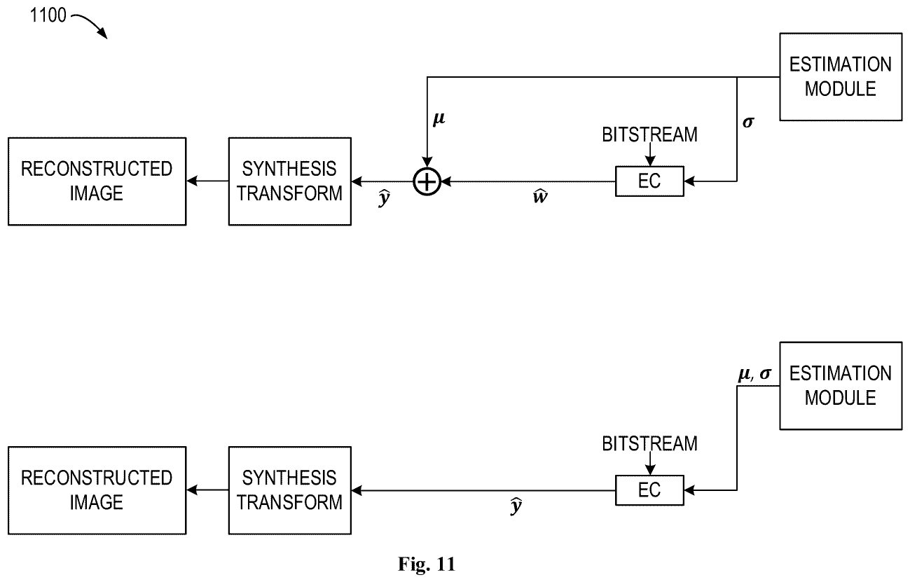

FIG. 11 illustrates corresponding decoder implementations for the encoder implementations shown in FIG. 10. FIG. 11 describes two possible alternative implementations of the decoder in an NN based video compression method. According to the first alternative, the estimation module estimates the mean values μ and other statistical properties (e.g. variance σ). The variance and optinally other statistical information are used by the entropy coder (denoted by EC) to decode the bitstream into quantized residual samples ŵ. Later the estimated mean values μ and the quantized residual samples ŵ are added together to obtain the quantized latent samples ŷ. ŷ is finally transformed into reconstructed picture by a synthesis transform. The first alternative decoder implementation is depicted in the upper flowchart in FIG. 11.

According to the second alternative, the estimation module estimates the mean values μ and other statistical properties (e.g. variance σ). The mean, variance and optinally other statistical information are used by the entropy coder (denoted by EC) to decode the bitstream into quantized residual samples quantized latent samples ŷ. ŷ is finally transformed into reconstructed picture by a synthesis transform. The second alternative decoder implementation is depicted in the bottom flowchart in FIG. 11.

In the above a sample of quantized latent is denoted by ŷ. It is noted that the sample is not necessarily a scalar value, it might be a vector and might contain multiple elements. In the rest of the application a sample can be denoted by ŷ[i, j] or ŷ[:, i, j], or ŷ[c, i, j]. In the latter, the “:” is used to denote that there is a third dimension and is used to stress that the sample has multiple elements.

### 3. Problems

### 3.1. The Core Problem

In the state-of-the-art, an autoregressive network is used to predict the samples of the quantized latent ŷ. The term autoregressive indicates self reference or self dependence. Previously obtained samples of ŷ are used to generate a prediction value, which is then used to obtain the next sample of ŷ. Since the obtaining of one sample of ŷ depends at least one previously obtained sample of ŷ, this process is autoregressive.

Once all samples of the ŷ is obtained, they are processed by a synthesis transform to obtain the reconstructed picture. The problem in the state-of-the-art is that, the same samples of ŷ are used by both of prediction module and the synthesis transform. This can be observed in FIG. 7 and FIG. 9, wherein the same ŷ is used by the “Decoder” module (in other words the synthesis transform) and in the loop that comprises “context” module. The “context” module is part of the prediction module that is used to predict the next samples of ŷ.

Accordingly, in-the-state-of the art, the same latent samples are used for obtaining the reconstructed picture via the synthesis transform and in the prediction of next latent samples. However, the sample values that result in a good prediction do not always result in the most visually pleasing reconstructed image. For example, human subjects might prefer a reconstructed image with sharp details and high contrast. On the other hand the latent samples that result in sharper reconstructed image require more side information to be transmitted (increased bitrate), since they are typically harder to predict.

### 4. Detailed Solutions

The detailed solutions below should be considered as examples to explain general concepts. These solutions should not be interpreted in a narrow way. Furthermore, these solutions can be combined in any manner.

### 4.1. Target of the Solution

The goal of the image compression is maximizing the quality of the output image while at the same time reducing the number of bits to be transmitted (bitrate). The solution proposes a method for increasing the quality of a reconstructed picture without increasing the bitrate for neural network-based image and video compression methods.

### 4.2. Core of the Solution

According to the solution the samples of quantized latent ŷ that is used by the synthesis transform are different from the samples that are used by the prediction module. The core of the solution comprises the steps of:
1. Obtaining a first sample of quantized latent ŷ,
2. Using the first sample to predict a second sample of ŷ (i.e. obtaining a prediction value),
3. Using the prediction to obtain the second sample of ŷ,
4. Modifying the first sample to obtain modified quantized latent ŷₛ,
5. Processing the ŷₛ by a synthesis transform to obtain the reconstructed picture.

In other words, the quantized latent is modified after it is used by the prediction and before the synthesis transform is applied.

### 4.2.1. An Example Implementation of the Solution

According to the solution, the reconstructed image is obtained according to following steps:

Firstly, the samples of the quantized latent are obtained autoregressively using the following steps:
1. Obtain a sample of a mean μ by using a prediction module. The input of the prediction module is previously obtained samples of the quantized latent ŷ.
2. Optionally obtain a sample of a residual ŵ from a bitstream.
3. Obtain a new sample of the quantized latent ŷ using the mean and/or residual sample.
4. Obtain a new sample of the modified quantized latent ŷₛ using the mean and/or residual sample and the quantized latent ŷ.

After the samples of the modified quantized latent ŷₛ are obtained a synthesis transform is applied to obtain the reconstructed picture.

### 4.2.1.1. Second Alternative

According to the solution, the reconstructed image is obtained according to following steps: Firstly, the samples of the quantized latent are obtained autoregressively using the following steps:
1. Obtain a sample of a mean μ by using a prediction module. The input of the prediction module is previously obtained samples of the quantized latent ŷ.
2. Optionally obtain a sample of a residual ŵ from a bitstream.
3. Obtain a new sample of the quantized latent ŷ using the mean and/or residual sample.

After the samples of ŷ are obtained, obtain the modified quantized latent ŷₛ using ŷ and mean μ (or residual ŵ).

A synthesis transform is applied to the modified quantized latent ŷₛ to obtain the reconstructed picture.

### 4.3. Difference Between the Solution and the State-of-the-Art

In the state of the art NN-based image and video coding systems, the reconstructed image is obtained according to following steps:

Firstly, the samples of the quantized latent are obtained autoregressively using the following steps:
1. Obtain a sample of a mean μ by using a prediction module. The input of the prediction module is previously obtained samples of the quantized latent ŷ.
2. Optionally obtain a sample of a residual ŵ from a bitstream.
3. Obtain a new sample of the quantized latent ŷ using the mean and/or residual sample.

Once all samples of the quantized latent ŷ are obtained a synthesis transform is applied to obtain the reconstructed picture.

In the state-of-the-art, the same samples of the quantized latent are used by prediction module and the synthesis transform. On the other hand, according to the solution the modified quantized latent samples are used by the synthesis transform are different from the quantized latent samples used in the prediction module.

### 4.4. Details of the Solution

Three possible implementations of the solution are detailed in this section.

### 4.4.1. Alternative Implementation 1

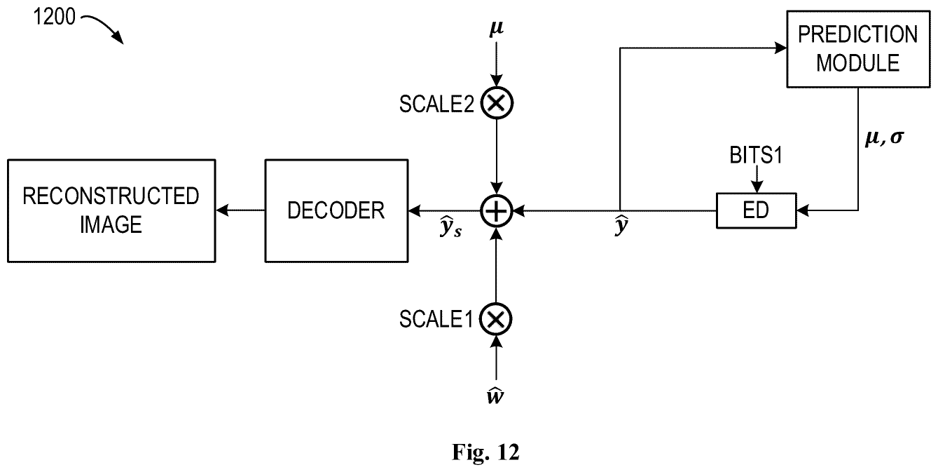

FIG. 12 illustrates a possible implementation of the solution in NN-based image compression. Decoder perspective is depicted. FIG. 12 depicts one of the possible implementations of the solution. According to the solution first a bitstream is received (denoted by bits1 or bits). The entropy decoder (ED) module decodes the bitstream to obtain the first sample of the quantized latent ŷ. Let's denote the first sample as ŷ₁. The ŷ₁ then used by the prediction module to obtain a second sample of statistical parameters μ₂ and/or σ₂. The statistical parameters might be (not limited to) a mean parameter μ or a variance parameter σ. The statistical parameters might also comprise parameters that can be used to describe a probability distribution. After the second sample of statistical parameters is obtained, it is used by the prediction module to obtain the second sample of the quantized latent ŷ₂. This process is repeated until all samples of the quantized latent is obtained.

As explained in the above paragraph, the first sample of quantized latent is used by the prediction module, whose output is used to obtain the second sample of the quantized latent. Due to the recursive nature of the process the obtaining of the quantized latent ŷ is an autoregressive process.

According to the solution the prediction of the second sample is performed using an autoregressive neural network or subnetwork (prediction module). The process of the prediction might predict a mean value μ or a variance parameter σ.

According to the first alternative implementation of the solution the samples of the quantized latent ŷ are obtained by the process of entropy decoding. The mean value μ is obtained by the prediction module using previously obtained samples of ŷ. The entropy coding module then uses mean value to obtain the next sample of ŷ. The samples of the quantized residual can be obtained according to the following equation.

$$\hat{w} = \hat{y} - μ$$

After the samples of ŷ are obtained, they are modified to obtain the quantized latent samples ŷₛ which are then used by the synthesis transform to obtain the reconstructed picture.

### 4.4.2. Alternative Implementation 2

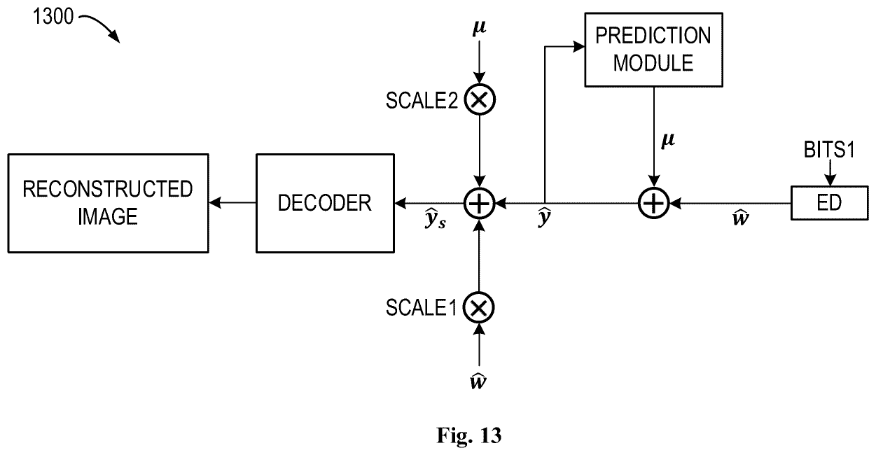

FIG. 13 illustrates another possible implementation of the solution in NN-based image compression. Decoder perspective is depicted.

The second alternative implementation (shown in FIG. 13) of the solution is same as the first alternative, except for how the quantized latent and quantized residual latent are obtained. According to the second alternative the output of the entropy decoding module (ED) is the quantized residual latent w, which is used to obtain the ŷ. The ŷ is obtained according to ŵ and mean value μ, wherein the mean value μ is obtained by application of the prediction module to the previously obtained samples of ŷ. Since the mean value is obtained using previously obtained samples, the prediction module is an autoregressive process. Furthermore, the prediction module comprises a neural network-based network or subnetwork.

After the samples of ŷ are obtained, they are modified to obtain the quantized latent samples ŷₛ which are then used by the synthesis transform to obtain the reconstructed picture.

### 4.4.3. Alternative Implementation 3

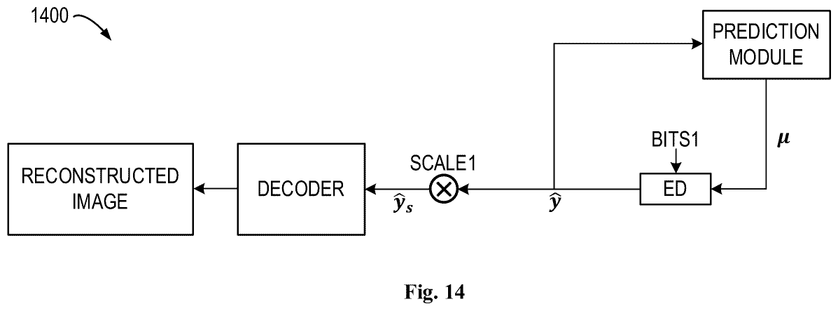

FIG. 14 illustrates another possible implementation of the solution in NN based image compression. Decoder perspective is depicted. Another possible implementation is depicted in FIG. 14. According to the alternative implementation, the samples of quantized latent are multiplied by a multiplier after they are used by the prediction module to obtain the modified quantized latent samples. The modified quantized latent samples are used by the synthesis transform (denoted as “decoder”) to obtain the reconstructed image.

In all alternative implementations described above, the values of the multipliers (scale1 and or scale2), or an indication thereof, might be obtained from a bitstream.

It is noted that the term decoder can be used to indicate both the “synthesis transform” and the whole decoding process (including the synthesis transform, prediction module and entropy decoding modules).

### 4.4.4. Further Details of the Solution

According to the solution the modified quantized latent ŷₛ can be obtained according to the one of the following equations. The m1, m2, and m3 are multipliers, they can be scalar numbers of vectors.

$$\begin{matrix}{\hat{y}}_{s} = \hat{y} \times m 1 + μ \times m 2 + \hat{w} \times m 3 , or \\ {\hat{y}}_{s} = \hat{y} \times m 1 + μ \times m 2 , or \\ {\hat{y}}_{s} = \hat{y} \times m 1 + \hat{w} \times m 2 , or \\ {\hat{y}}_{s} = \hat{y} + μ \times m 1 + \hat{w} \times m 2 , or \\ {\hat{y}}_{s} = \hat{y} + μ \times m 1 , or \\ {\hat{y}}_{s} = \hat{y} + \hat{w} \times m 1 , or \\ {\hat{y}}_{s} = μ \times m 1 + \hat{w} \times m 2 , or \\ {\hat{y}}_{s} = \hat{y} + \hat{y} \times m 1 , or \\ {\hat{y}}_{s} = \hat{y} \times m 1 \\ …\end{matrix}$$

Additionally, alternatively quantized latent ŷₛ can be obtained according to the one of the following equations. The a1 is an additive term, which can be a scalar number, or a vector of numbers.

$${\hat{y}}_{s} = \hat{y} + a 1$$

The value of the additive term a1 might be included in the bitstream by an encoder and decoded from the bitstream by the decoder.

The additive term a1 and the multiplicative terms m1, m2 and m3 can be applied together. Examples are as follows:

$$\begin{matrix}{\hat{y}}_{s} = \hat{y} \times m 1 + μ \times m 2 + \hat{w} \times m 3 + a 1 , or \\ {\hat{y}}_{s} = \hat{y} \times m 1 + μ \times m 2 + a 1 , or \\ {\hat{y}}_{s} = \hat{y} \times m 1 + \hat{w} \times m 2 + a 1 , or \\ {\hat{y}}_{s} = \hat{y} + μ \times m 1 + \hat{w} \times m 2 + a 1 , or \\ {\hat{y}}_{s} = \hat{y} + μ \times m 1 + a 1 , or \\ {\hat{y}}_{s} = \hat{y} + \hat{w} \times m 1 + a 1 , or \\ {\hat{y}}_{s} = μ \times m 1 + \hat{w} \times m 2 + a 1 , or \\ {\hat{y}}_{s} = \hat{y} + \hat{y} \times m 1 + a 1 , or \\ {\hat{y}}_{s} = \hat{y} \times m 1 + a 1 \\ …\end{matrix}$$

According to one example implementation, the modified samples of ŷₛ are obtained according to (and not limited to) at least two of the quantized latent (ŷ), residual quantized latent ( ) and mean (u). For example the modified quantized latent (ŷₛ) can be obtained according to ŷ and ŵ. Or it can be obtained using ŷ and μ. Or it can be obtained according to ŷ, ŵ and μ. It is noted that according to the solution, the at least one sample of the modified quantized latent ŷₛ is different from the quantized latent ŷ.

The entropy decoder module might use the variance and mean parameters to obtain a probability distribution, such as a gaussian distribution. For example the gaussian distribution might be obtained using the equation:

$$f ( x ) = \frac{1}{σ \sqrt{2 π}} {e}^{- \frac{1}{2} {( \frac{x - μ}{σ} )}^{2}} ,$$

wherein the variance σ and mean μ parameters are used in the equation. The probability distribution is then used to obtain the quantized residual latent or quantized latent.

Once the modified quantized latent ŷₛ it is used to obtain the reconstructed picture by applying an synthesis transform. The synthesis transform might be a neural network-based subnetwork consisting of convolution or deconvolution layers. This is the core of the solution, i.e. using the samples of quantized latent ŷ to obtain the further samples of ŷ and further modifying ŷ before the synthesis transform. In other words the core of the solution comprises the steps of:
1. Obtaining a first sample of quantized latent ŷ,
2. Using the first sample to predict a second sample of ŷ,
3. Using the prediction to obtain the second sample of ŷ,
4. Modifying the first sample to obtain modified quantized latent ŷₛ,
5. Processing the ŷₛ by a synthesis transform to obtain the reconstructed picture.

The values of the multipliers (or an indication thereof) might be included in the bitstream and decoded by the decoder.

A sample of the quantized latent ŷ might be modified selectively according to a rule. For example the rule might comprise one of the following:
A sample of quantized latent ŷ is modified if the value of an associated probability parameter is smaller than (or greater than) a threshold value. For example if the value of a variance parameter σ [c, i, j] is smaller than a threshold, the sample in the corresponding position (e.g. ŷ[:, i, j]) can be modified to obtain ŷₛ [:, i, j], whereas if the σ [c, i, j] is greater than or equal to a threshold, ŷₛ [:, i, j] can be obtained by setting it equal to ŷ[:, i, j].
A function of the probability parameter can be used for determining which sample of ŷ is modified. For example the equation F (σ[c, i, j])<thr can be used to determine if the corresponding sample at position [c, i, j] is modified or not.
   The said probability parameter could be a variance value.
   The function might be in the form of a probability distribution or a cumulative probability distribution. One example if a gaussian probability distribution

$$( e . g . f ( x ) = \frac{1}{σ \sqrt{2 π}} {e}^{- \frac{1}{2} {( \frac{x - μ}{σ} )}^{2}} ) ,$$

A sample of quantized latent ŷ is modified according to its index value. For example, a sample ŷ[c, i, j] might be modified if the value of the index c is equal to a predetermined index value K. Or in another example the sample ŷ [c, i, j] might be modified if index i greater than a predetermined index value T. The index c might indicate the “channel number” of “feature map id”. Whereas the indices i, j indicate spatial coordinates of the sample. The values K and/or T might be included in the bitstream and obtained by the decoder from the bitstream. Or the values of K and/or T might be predetermined. Combinations of checking an index “greater than”, “smaller than”, “equal to” a value might be employed to determine sample if the sample ŷ [c, i, j] belongs to a first subset or not.

### 4.4.5. Encoding Process According to the Solution

In the encoder y̅ₛ is obtained in a similar manner as the decoder.

For example, ŷₛ is obtained according to one of the following equations.

$$\begin{matrix}{\hat{y}}_{s} = \hat{y} \times m 1 + μ \times m 2 + \hat{w} \times m 3 , or \\ {\hat{y}}_{s} = \hat{y} \times m 1 + μ \times m 2 , or \\ {\hat{y}}_{s} = \hat{y} \times m 1 + \hat{w} \times m 2 , or \\ {\hat{y}}_{s} = \hat{y} + μ \times m 1 + \hat{w} \times m 2 , or \\ {\hat{y}}_{s} = \hat{y} + μ \times m 1 , or \\ {\hat{y}}_{s} = \hat{y} + \hat{w} \times m 1 , or \\ {\hat{y}}_{s} = μ \times m 1 + \hat{w} \times m 2 , or \\ {\hat{y}}_{s} = \hat{y} + \hat{y} \times m 1 , or \\ {\hat{y}}_{s} = \hat{y} \times m 1 , or \\ {\hat{y}}_{s} = \hat{y} \times m 1 + μ \times m 2 + \hat{w} \times m 3 + a 1 , or \\ {\hat{y}}_{s} = \hat{y} \times m 1 + μ \times m 2 + a 1 , or \\ {\hat{y}}_{s} = \hat{y} \times m 1 + \hat{w} \times m 2 + a 1 , or \\ {\hat{y}}_{s} = \hat{y} + μ \times m 1 + \hat{w} \times m 2 + a 1 , or \\ {\hat{y}}_{s} = \hat{y} + μ \times m 1 + a 1 , or \\ {\hat{y}}_{s} = \hat{y} + \hat{w} \times m 1 + a 1 , or \\ {\hat{y}}_{s} = μ \times m 1 + \hat{w} \times m 2 + a 1 , or \\ {\hat{y}}_{s} = \hat{y} + \hat{y} \times m 1 + a 1 , or \\ {\hat{y}}_{s} = \hat{y} \times m 1 + a 1 , \\ {\hat{y}}_{s} = \hat{y} + a 1 , \\ …\end{matrix}$$

The encoder determines the values of the multipliers according to a quality metric. In one example it might test different values of multipliers to determine which one results in a highest quality. The quality metric can be mean squared error, or MS-SSIM or such. Then it might include the multiplier (or an indication thereof) in the bitstream so that the decoder can replicate the result obtained by the encoder.

### 4.5. Benefit of the Solution

By modifying the quantized latent before performing the synthesis transform, the artifacts caused by the conversion process may be at least partially eliminated, and thus the reconstructed image may be more visually pleasing.

### 5. Embodiments

1. Decoder embodiment:
An image or video decoding method, comprising at least one step of the following:
   Obtaining a first sample of a quantized latent ŷ using a bitstream and a prediction module,
   Using the said first sample to obtain a second sample of the quantized latent,
   Obtaining a first sample of modified quantized latent ŷₛ according to the first sample of the quantized latent ŷ,
Obtaining the reconstructed image using the modified quantized latent ŷₛ, which may be used together with a synthesis transform.

2. According to embodiment 1,
Obtaining a first sample of modified quantized latent ŷₛ comprises;
   Obtaining an additive term,
   Obtaining a first sample of modified quantized latent ŷₛ according to the first sample of the quantized latent ŷ and the additive term.

3. According to embodiments 2;
The step of obtaining the additive term comprises obtaining a first sample of a quantized residual ŵ from a bitstream.

4. According to embodiments 3;
The said first sample of the quantized residual ŵ is used in obtaining the first sample of the quantized latent ŷ.

5. According to embodiments 2;
The step of obtaining the additive term comprises obtaining a first sample of a mean μ using the prediction module.

6. According to embodiments 5;
The said first sample of the mean μ is used in obtaining the first sample of the quantized latent ŷ.

7. According to embodiments 5 and 6;
The first sample of a mean μ is obtained by the prediction module by using at least one other sample of the quantized latent ŷ.

8. According to embodiments 2;
The step of obtaining the additive term comprises obtaining a first sample of a mean μ from a bitstream.

9. According to embodiments 5 to 8;
The said first sample of the mean μ is used in obtaining the first sample of the quantized latent ŷ.

10. According to embodiment 2;
The value of the additive term (or an indication thereof) is obtained from the bitstream.

11. According to embodiment 2;
The additive term is quantized latent ŷ, and the modified quantized latent ŷₛ is obtained according to ŷₛ=ŷ×m1 or ŷₛ=ŷ+ŷ×m2 wherein m1 is not equal to 1, m2 is not equal to 0.

12. According to embodiment 1;
First sample of modified quantized latent is obtained according to ŷ=ŷ×m1.

13. According to any of the embodiments above,
The step of obtaining the additive term comprises subtracting a sample of the mean μ from a sample of the quantized latent ŷ.

14. According to any of the embodiments above,
The step of obtaining the additive term comprises subtracting the first sample of the mean μ from the first sample of the quantized latent.

15. According to any of the embodiments above,
The quantized latent ŷ and the modified quantized latent ŷₛ comprise at least a second samples, wherein the said first sample of quantized latent is used by the prediction module to obtain a second sample of the mean μ.

16. According to embodiment 15,
The second sample of the mean μ is used to obtain the second sample of quantized latent ŷ.

17. According to embodiment 16,
The second sample of the modified quantized latent ŷₛ is obtained by using the second sample of the quantized latent ŷ.

18. According to any of the embodiments above,
The prediction module comprises a neural subnetwork.

19. According to any of the embodiments above,
The prediction module is an autoregressive subnetwork.

20. According to any of the embodiments above,
The prediction module receives a previously obtained the quantized latent ŷ as input, processes the input.

21. According to any of the embodiments above,
The prediction module comprises a context subnetwork or a hyper decoder subnetwork.

22. According to any of the embodiments above,
Including the multiplier (or an indication thereof) in the bitstream.

23. According to any of the embodiments above,
The multiplier is a scalar value that is different from 0.

24. According to any of the embodiments above,
The multiplier is a vector.

25. According to any of the embodiments above,
The synthesis transform is a neural sub-network.

26. According to any of the embodiments above, including the value of at least one piece of control information, which can determine whether to and/or how to apply any methods mentioned above.

27. Whether to and/or how to apply any methods mentioned above may depend on a condition, such as the colour format and/or colour component.

28. According to any of the embodiments above, any value included in the bitstream may be coded at sequence/picture/slice/block level.

29. According to any of the embodiments above, any value included in the bitstream may be binarized before being coded.

30. According to any of the embodiments above, any value included in the bitstream may be coded with at least one arithmetic coding context.

More details of the embodiments of the present disclosure will be described below which are related to neural network-based visual data coding. As used herein, the term “visual data” may refer to an image, a picture in a video, or any other visual data suitable to be coded.

As discussed above, in the existing design, a quantized latent representation of visual data is directly used for the synthesis transform to reconstruct the visual data. However, the conventional conversion process may be subject to artifacts, which render the reconstructed visual data less visually pleasing.

To solve the above problems and some other problems not mentioned, visual data processing solutions as described below are disclosed.

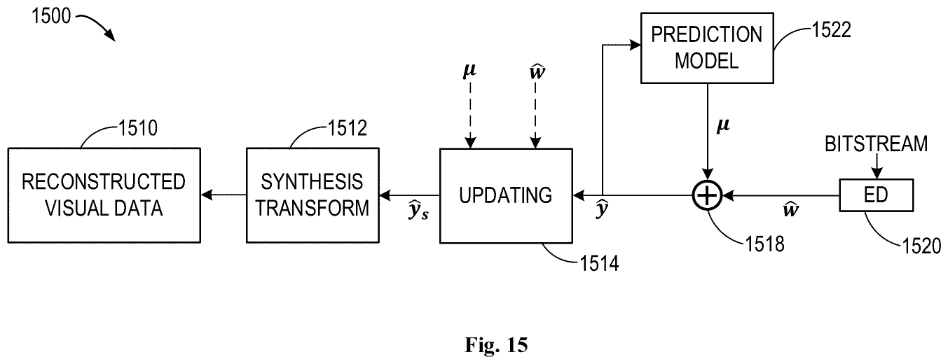

FIG. 15 illustrates an example visual data decoding process 1500 according to some embodiments of the present disclosure. For example, the visual data decoding process 1500 may be performed by the visual data decoder 124 as shown in FIG. 1. It should be understood that the visual data decoding process 1500 may also include additional blocks not shown, and/or blocks shown may be omitted. The scope of the present disclosure is not limited in this respect.

As shown in FIG. 15, the bitstream may be inputted into an entropy decoder 1520. At the entropy decoder 1520, an entropy decoding process may be performed on the bitstream to obtain a quantized residual latent representation (denoted as ŵ in FIG. 15) of the visual data. It should be noted that a quantized residual latent representation may also be referred to as a quantization of the residual latent representation. Similarly, a quantized latent representation may also be referred to as a quantization of the latent representation. The residual latent representation and/or the quantized residual latent representation may indicate a difference between a latent representation of the visual data and a prediction of the latent representation.

By way of example rather than limitation, the entropy decoding process may be performed based on probability distribution information generated by a factorized entropy subnetwork (not shown in FIG. 15). In some embodiments, the factorized entropy subnetwork may generate the probability distribution information by using a predetermined template, for example by using predetermined mean and variance values in the case of gaussian distribution. The entropy decoding process performed by the entropy decoder 1520 may be an arithmetic decoding process, a Huffman decoding process, or the like.

At block 1518, a quantized latent representation (denoted as ŷ in FIG. 15) of the visual data may be obtained by adding the quantized residual latent representation and a prediction (denoted as μ in FIG. 15) of the latent representation generated by the prediction model 1522. The prediction model 1522 may be implemented with a neural network. It should be noted that a model may also be referred to as a module in the present application. That is, the prediction model may also be referred to as a prediction module, and the estimation model may also be referred to as an estimation module. In some embodiments, this process may be determined at a sample-level. In other words, a sample of the quantized latent representation may be obtained by adding a corresponding sample of the quantized residual latent representation and a prediction of the sample.

In some embodiments, the prediction model 1522 may be autoregressive. In one example, the prediction model 1522 may comprise a context subnetwork and a prediction fusion subnetwork (not shown in FIG. 15). At least one reconstructed sample of the quantized latent representation ŷ may be input to the context subnetwork. The at least one reconstructed sample is previously obtained and used for generating a prediction of a current sample of the quantized latent representation ŷ without being adjusted. The context subnetwork may generate intermediate information based on the at least one reconstructed sample. By way of example rather than limitation, the intermediate information may reflect the mean value of the at least one reconstructed sample. The prediction fusion subnetwork may generate a prediction of the current sample based on the intermediate information. In one example, the prediction may indicate a predicted mean value of the current sample. The obtained prediction may be added up with a corresponding sample of the quantized residual latent representation ŵ to reconstruct the current sample. The above-mentioned process may be repeated, so as to reconstruct all samples of the quantized latent representation ŷ.

It should be understood that the context subnetwork 1426 may also be referred to as a context model, a context model subnetwork, and/or the like. Moreover, the prediction fusion subnetwork may also be referred to as a fusion subnetwork, a prediction subnetwork, and/or the like. Moreover, the prediction model 1522 may also be implemented in any other suitable manner, e.g., a multistage context model may be employed, and the prediction fusion subnetwork may be removed. The scope of the present disclosure is not limited in this respect.

At block 1514, the quantized latent representation ŷ may be updated to obtain an intermediate representation (denoted as ŷₛ in FIG. 15) of the visual data. The intermediate representation is different from the quantized latent representation. In some embodiments, the updating process may be performed at a sample-level. In other words, the updating process is performed sample by sample. Alternatively, after all samples of the quantized latent representation ŷ are obtained, the updating process may be performed on the entire quantized latent representation.

In some embodiments, at least a part of the quantized latent presentation may be updated based on at least one of: at least one parameter, a prediction of the at least a part of the quantized latent presentation, or a difference between the prediction and quantized latent presentation. By way of example rather than limitation, the at least one parameter may be determined based on a quality metric at the encoder side or the decoder side. The quality metric may comprise a mean squared error, a structural similarity (SSIM), a multiscale structure similarity (MS-SSIM), and/or the like. In one example, the at least one parameter may be a scalar value different from zero or a vector. The at least one parameter may be signaled in the bitstream. Alternatively, an indication of the at least one parameter may be signaled in the bitstream.

In some embodiments, the at least a part of the quantized latent presentation may be updated by scaling the at least a part with a first parameter. Additionally or alternatively, the at least a part of the quantized latent presentation may be updated based on a product of the prediction and a second parameter and/or a product of the difference and a third parameter. In some additional or alternative embodiments, the at least a part of the quantized latent presentation may be updated by adding a fourth parameter. This is described in detail at the above section 4.4.4, where possible equations used for the updating process is listed for illustrative and non-limiting purpose.

In some embodiments, different samples of the quantized latent presentation may be adjusted in different manners, such as with different parameters. Additionally or alternatively, a set of samples of the quantized latent presentation may not be updated. In other words, the samples of the quantized latent presentation may be updated selectively.

In some embodiments, a grouping process may be performed at the updating block 1514 for the selective updating, so as to determine the at least a part of the quantized latent presentation which need to be updated or to be updated in a specific manner. In one example, this grouping process may be performed at a sample-level. In other words, the determination of the least a part is made for each of the samples of the quantized latent representation. Alternatively, the grouping process may be performed at a block-level. More specifically, the samples of the quantized residual latent representation may be divided into a plurality of blocks. Each of the plurality of blocks may have a predetermined size of N by M, such as 8×8. Each of N and M is a positive integer. N and M may be indicated in the bitstream. The samples may be grouped based on the plurality of blocks. In other words, the determination of the least a part is made for each of the plurality of blocks, and samples in the same block are divided into the same set.

In some embodiments, for a sample of the quantized latent representation, if a statistical value corresponding to the sample is smaller than a first threshold, it may be determined that the at least a part comprises the sample, and the sample may be grouped into a first set. Otherwise, it may be determined that the sample will not be comprised into the at least a part, and the sample may be grouped into a second set different from the first set. By way of example rather than limitation, the statistical value may be a variance, such as a variance of a gaussian probability. The variance may be generated based on the bitstream by using a hyper scale decoder subnetwork. It should be understood that any other suitable statistical value(s), such as a mean or a standard deviation, may also be used. Furthermore, a statistical value may also be referred to as a statistical parameter, a probability parameter, a probability distribution parameter, or the like. The scope of the present disclosure is not limited in this respect.

Alternatively, for a sample of the quantized latent representation, if a statistical value corresponding to the sample is larger than a further threshold which may be the same as or different from the first threshold, it may be determined that the at least a part comprises the sample, and the sample may be grouped into the first set. Otherwise, it may be determined that the sample will not be comprised into the at least a part, and the sample may be grouped into the second set. The above-mentioned comparison may be performed for each of the samples of the quantized residual latent representation, so as to obtain the at least a part.

It should be understood that the at least a part may be determined in any other suitable manner, such as, based on a comparison between a threshold and a value determined based on the statistical value, or based on a comparison between a threshold and an index of the sample. For example, an index of a sample may indicate a channel number of the sample, a feature map identifier of the sample, or a spatial coordinate of the sample. This is described in detail at the above section 4.4.4.

In some alternative embodiments, the grouping process may be performed at a block-level. In such a case, for samples in a block of the quantized latent representation, if a statistical value corresponding to each sample in the block is smaller than a fourth threshold, it may be determined that the at least a part comprises all of samples in the block, and these samples may be grouped into a first set. Otherwise, it may be determined that these samples will not be comprised into the at least a part, and these samples may be grouped into a second set different from the first set.

Alternatively, for samples in a block of the quantized latent representation, if a statistical value corresponding to each sample in the block is larger than a further threshold which may be the same as or different from the fourth threshold, it may be determined that the at least a part comprises all of samples in the block, and these samples may be grouped into a first set. Otherwise, it may be determined that these samples will not be comprised into the at least a part, and these samples may be grouped into a second set. The above-mentioned comparison may be performed for each of the blocks of the quantized residual latent representation, so as to obtain the at least a part.

It should be understood that the at least a part may be determined in any other suitable manner, such as, based on a comparison between a threshold and a metric determined based on statistical values corresponding the samples, or based on a comparison between a threshold and an index of each of the samples. By way of example, the metric may be an average, a minimum, a maximum, a specific function, or the like. In one example, at least one of the thresholds may be indicated in the bitstream. Alternatively, at least one indication of the at least one of the thresholds may be indicated in the bitstream.

Alternatively, it may be determined sample by sample or block by block whether a sample or samples in a block need to be updated, and the updating process may be performed on the corresponding sample or samples in a block after the determination. By way of example rather than limitation, for a sample of the quantized latent representation, if a statistical value corresponding to the sample is smaller than a threshold, it may be determined that the sample is to be updated. Then, this sample may be updated based on the above-mentioned updating process. Similarly, for samples in a block of the quantized latent representation, if a statistical value corresponding to each sample in the block is smaller than a threshold, it may be determined that it may be determined that the samples in the block are to be updated. Then, these samples may be updated based on the above-mentioned updating process. It should be noted that this determination may also be made based on any other suitable parameter(s) and/or value(s), such as a value determined based on the statistical value, or an index of the sample. The scope of the present disclosure is not limited in this respect.

After obtaining the at least a part of the quantized latent representation, the above described updating process may be performed on it. It should be understood that the at least a part of the quantized latent representation may comprise one or more samples, or even all samples of the quantized latent representation. In a case that the at least a part of the quantized latent representation comprises all samples of the quantized latent representation, and the intermediate representation corresponds to a result of the updating the at least a part.

At the synthesis transform block 1512, a synthesis transform may be performed on the intermediate representation ŷₛ to obtain the reconstructed visual data 1510. For example, the synthesis transform may be performed by using a neural network-based subnetwork. It should be noted that at least part of samples used for the synthesis transform is different from the samples used for the prediction model 1522.

In view of the foregoing, an intermediate representation different from a quantized latent representation of the visual data is generated and used for the synthesis transform. Compared with the conventional solution where the quantized latent representation is directly used for the synthesis transform, the proposed method can at least partially eliminate artifacts caused by the conventional conversion process, and thus the reconstructed image may be more visually pleasing. Thereby, the proposed method can advantageously improve the coding quality.

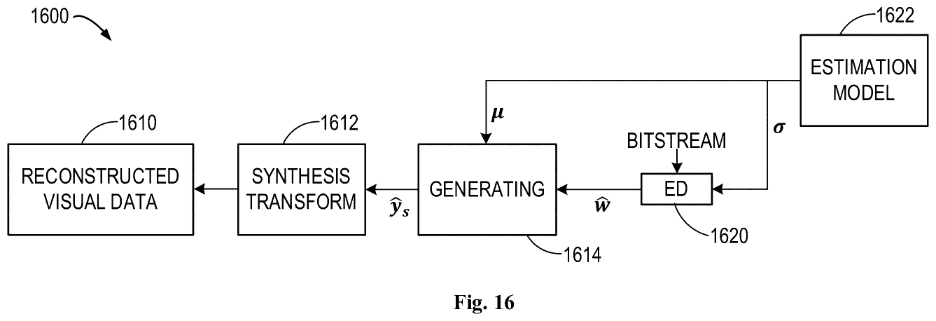

FIG. 16 illustrates another example visual data decoding process 1600 according to some embodiments of the present disclosure. For example, the visual data decoding process 1600 may be performed by the visual data decoder 124 as shown in FIG. 1. It should be understood that the visual data decoding process 1600 may also include additional blocks not shown, and/or blocks shown may be omitted. The scope of the present disclosure is not limited in this respect.

As shown in FIG. 16, the bitstream may be inputted into an entropy decoder 1620. At the entropy decoder 1620, an entropy decoding process may be performed on the bitstream to obtain a quantized residual latent representation (denoted as ŵ in FIG. 16) of the visual data. The entropy decoding process may be performed based on a first statistical value generated by an estimation model 1622. The estimation model 1622 may also be implemented with a neural network. By way of example rather than limitation, the first statistical value may be a variance (denoted as σ in FIG. 16), such as a variance of a gaussian probability. It should be understood that any other suitable statistical value(s), such as a mean or a standard deviation, may also be used. The scope of the present disclosure is not limited in this respect.

In addition to the first statistical value, the estimation model 1622 further generates a second statistical value (denoted as μ in FIG. 16). In some embodiments, the second statistical value may indicate a prediction of a latent representation of the visual data. By way of example rather than limitation, the second statistical value may be a mean, such as a mean of a gaussian probability. In one example, the first and second statistical values may be generated by the estimation model 1622 jointly. Alternatively, the estimation model 1622 may comprise a first subnetwork for generating the first statistical value and a second subnetwork for generating the second statistical value. By way of example rather than limitation, the first subnetwork may be a hyper scale decoder subnetwork, and the second subnetwork is a hyper decoder subnetwork.

At the generating block 1614, an intermediate representation (denoted as ŷₛ in FIG. 16) of the visual data may be generated based on the second statistical value μ and the quantized residual latent representation ŵ. It should be noted that since the second statistical value μ indicates a prediction of the latent representation, it may also be referred to as “the prediction” hereinafter. Similarly, since the quantized residual latent representation ŵ indicates a difference between the prediction and the latent representation, it may also be referred to as “the difference” hereinafter. In some embodiments, at least a part of the intermediate representation may be generated by adding up a product of the prediction and a first parameter and a product of the difference and a second parameter. Alternatively, the at least a part of the intermediate representation may be generated by adding up the product of the prediction and the first parameter, the product of the difference and the second parameter, and a third parameter. This is described in detail at the above section 4.4.4, where possible equations used for the generating the intermediate representation ŷₛ based on the prediction μ and the quantized residual latent representation ŵ is listed for illustrative and non-limiting purpose.

It should be noted that since a sum of the prediction μ and the quantized residual latent representation ŵ is the quantized latent presentation ŷ. Thus, the above generating process may be considered as an equivalent of the updating process described with regard to the updating block 1514 in FIG. 15. As such, the intermediate representation ŷₛ may also be generated in a selective manner similar to the above-described selective update.

At the synthesis transform block 1612, a synthesis transform may be performed on the intermediate representation ŷₛ to obtain the reconstructed visual data 1610. For example, the synthesis transform may be performed by using a neural network-based subnetwork.

In view of the foregoing, an intermediate representation different from a quantized latent representation of the visual data is generated and used for the synthesis transform. Compared with the conventional solution where the quantized latent representation is directly used for the synthesis transform, the proposed method can at least partially eliminate artifacts caused by the conventional conversion process, and thus the reconstructed image may be more visually pleasing. Thereby, the proposed method can advantageously improve the coding quality.

Although two example visual data decoding processes are described above with respect to FIGS. 15 and 16, it should be understood that any other suitable variants of the visual data decoding process are also conceivable in view of the present disclosure, such as the two further example visual data decoding processes shown illustratively in FIGS. 12 and 14.

Moreover, although the proposed method is described from a decoder perspective, it may also be implemented at an encoder, such as in order to reconstruct the encoded visual data. The scope of the present disclosure is not limited in this respect. It should be understood that the above illustrations and/or examples are described merely for purpose of description. The scope of the present disclosure is not limited in this respect. The embodiments of the present disclosure should be considered as examples to explain the general concepts and should not be interpreted in a narrow way. Furthermore, these embodiments can be applied individually or combined in any manner.

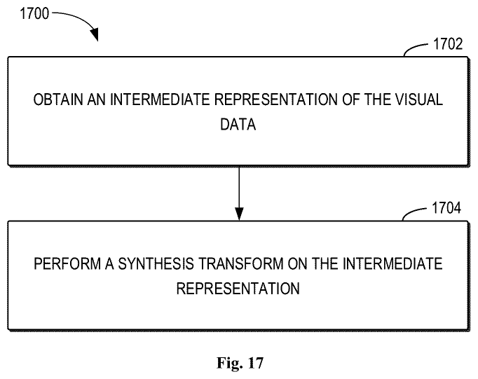

FIG. 17 illustrates a flowchart of a method 1700 for visual data processing in accordance with some embodiments of the present disclosure. The method 1700 may be implemented during a conversion between the visual data and a bitstream of the visual data. As shown in FIG. 17, the method 1700 starts at 1702, where an intermediate representation of the visual data is obtained. The intermediate representation is different from a quantized latent representation of the visual data. Moreover, the intermediate representation is generated based on at least one of the following: at least one parameter, at least a part of the quantized latent representation, a prediction of the at least a part of the quantized latent representation, or a difference between the prediction and the at least a part of the quantized latent representation. The quantized latent representation is generated based on applying a first neural network to the visual data.

In some embodiments an analysis transform may be performed on the visual data by using the first neural network, to obtain a latent representation of the visual data. The visual data may comprise an image or one or more pictures in a video. A first statistical value may be subtracted from the latent representation, so as to obtain a residual latent representation. The first statistical value may be generated by a second neural network and indicate a prediction of the latent representation. By way of example rather than limitation, the first statistical value may be a mean of a probability distribution, such as a gaussian probability distribution. For example, the probability distribution may describe a probability distribution of the value of one or more samples of the latent representation.

At 1704, a synthesis transform is performed on the intermediate representation for the conversion. In one example, the conversion may include encoding the visual data into the bitstream. Alternatively or additionally, the conversion may include decoding the visual data from the bitstream. It should be understood that the above illustrations are described merely for purpose of description. The scope of the present disclosure is not limited in this respect.

In view of the foregoing, an intermediate representation different from a quantized latent representation of the visual data is generated and used for the synthesis transform. Compared with the conventional solution where the quantized latent representation is directly used for the synthesis transform, the proposed method can at least partially eliminate artifacts caused by the conventional conversion process, and thus the reconstructed image may be more visually pleasing. Thereby, the proposed method can advantageously improve the coding quality.

In some embodiments, at 1702, the at least a part of the quantized latent representation may be obtained. Furthermore, the at least a part of the quantized latent representation may be generated based on at least one of the at least one parameter, the prediction or the difference, so as to obtain at least a part of the intermediate representation.

In some embodiments, the at least a part of the quantized latent representation may be updated by scaling the at least a part of the quantized latent representation with a first parameter of the at least one parameter. Additionally or alternatively, the at least a part of the quantized latent representation may be updated based on a product of the prediction and a second parameter of the at least one parameter and/or a product of the difference and a third parameter of the at least one parameter. Additionally or alternatively, the at least a part of the quantized latent representation may be updated by at least adding a fourth parameter of the at least one parameter.

In some embodiments, the prediction may be a mean. The difference may be comprised in a quantized residual latent representation of the visual data. In some embodiments, an entropy decoding process may be performed on the bitstream to obtain the at least a part of the quantized latent representation. In some embodiments, the method may further comprise generating the prediction by using a first model. In some embodiments, the difference may be obtained by performing an entropy decoding process on the bitstream. The prediction may be generated by using a first model. The at least a part of the quantized latent representation may be generated based on the prediction and the difference.

In some embodiments, a prediction of a sample in the at least a part of the quantized latent representation may be generated based on at least one reconstructed sample of the quantized latent representation by using the first model. In one example, the first model may be a prediction model. By way of example rather than limitation, the first model may be autoregressive. For example, the first model may comprise a context subnetwork or a context model subnetwork.

In some embodiments, the at least a part of the quantized latent representation may comprise all samples of the quantized latent representation, and the intermediate representation corresponds to a result of the updating. In some further embodiments, the method may further comprise: updating a further part of the quantized latent representation based on at least one further parameter different from the at least one parameter. The further part is different from the at least a part of the quantized latent representation.

In some embodiments, at 1702, at least a part of the intermediate representation may be generated based on the prediction and the difference.

In some embodiments, the at least a part of the intermediate representation may be generated by adding up a product of the prediction and a first parameter of the at least one parameter, and a product of the difference and a second parameter of the at least one parameter. Alternatively, the at least a part of the intermediate representation may be generated by adding up the product of the prediction and the first parameter, the product of the difference and the second parameter, and a third parameter of the at least one parameter.

In some embodiments, at least one of the prediction or the difference may be generated by using a first model. In one example, the first model may be an estimation model. For example, the first model may comprise a neural network-based subnetwork. An input of the first model may comprise the bitstream. In some embodiments, the first model may comprise a first subnetwork for generating the prediction and a second subnetwork for generating a statistical value. By way of example rather than limitation, the first subnetwork may be a hyper decoder subnetwork, and the second subnetwork may be a hyper scale decoder subnetwork.

In some embodiments, the method may further comprise determining the at least a part of the quantized latent representation from the quantized latent representation. In one example, whether the at least a part of the quantized latent representation comprises a sample of the quantized latent representation may be determined based on at least one of the following: a comparison between a first threshold and a statistical value corresponding to the sample, a comparison between a second threshold and a value determined based on the statistical value, or a comparison between a third threshold and an index of the sample.

Alternatively, whether the at least a part of the quantized latent representation comprises samples in a block of the quantized latent representation may be determined based on at least one of the following: a comparison between a fourth threshold and a statistical value corresponding each of the samples, a comparison between a fifth threshold and a metric determined based on statistical values corresponding the samples, or a comparison between a sixth threshold and an index of each of the samples. In some embodiments, the metric may be an average, a minimum or a maximum. An index of a sample may indicate one of the following: a channel number of the sample, a feature map identifier of the sample, or a spatial coordinate of the sample.

In some embodiments, at least one of the following thresholds or an indication of at least one of the following may be indicated in the bitstream: the first threshold, the second threshold, the third threshold, the fourth threshold, the fifth threshold, or the sixth threshold. In some embodiments, the statistical value may be a variance. For example, the statistical value may be a variance of a gaussian probability. The statistical value may be obtained based on the bitstream by using the second subnetwork.

In some embodiments, the at least one parameter or an indication of the at least one parameter may be comprised in the bitstream. For example, the at least one parameter may be a scalar value different from zero or a vector. In one example, the at least one parameter may be determined based on a quality metric. By way of example rather than limitation, the quality metric may comprise at least one of the following: a mean squared error, a structural similarity (SSIM), or a multiscale structure similarity (MS-SSIM).

In some embodiments, the at least a part of the quantized latent representation may comprise one or more samples of the quantized latent representation. In some embodiments, the synthesis transform may be performed by using a neural network-based subnetwork.

In some embodiments, at least one of the following may be indicated the bitstream: information on whether to apply the method, or information on how to apply the method. In some alternative embodiments, at least one of the following may be dependent on a color format and/or a color component of the visual data: information on whether to apply the method, or information on how to apply the method.

In some embodiments, a value included in the bitstream may be coded at one of the following: a sequence level, a picture level, a slice level, or a block level. In some embodiments, a value included in the bitstream may be binarized before may be coded. In some embodiments, a value included in the bitstream may be coded with at least one arithmetic coding context.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: obtaining an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; and generating the bitstream based on a synthesis transform on the intermediate representation, wherein the quantized latent representation is generated based on applying a first neural network to the visual data.

According to still further embodiments of the present disclosure, a method for storing a bitstream of visual data is provided. The method comprises: obtaining an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; generating the bitstream based on a synthesis transform on the intermediate representation; and storing the bitstream in a non-transitory computer-readable recording medium, wherein the quantized latent representation is generated based on applying a first neural network to the visual data.

Implementations of the present disclosure can be described in view of the following clauses, the features of which can be combined in any reasonable manner.

Clause 1. A method for visual data processing, comprising: obtaining, for a conversion between visual data and a bitstream of the visual data, an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; and performing, for the conversion, a synthesis transform on the intermediate representation, wherein the quantized latent representation is generated based on applying a first neural network to the visual data.

Clause 2. The method of clause 1, wherein obtaining the intermediate representation comprises: obtaining the at least a part of the quantized latent representation; and updating the at least a part of the quantized latent representation based on at least one of the at least one parameter, the prediction or the difference, to obtain at least a part of the intermediate representation.

Clause 3. The method of clause 2, wherein updating the at least a part of the quantized latent representation comprises at least one of: scaling the at least a part of the quantized latent representation with a first parameter of the at least one parameter; updating the at least a part of the quantized latent representation based on a product of the prediction and a second parameter of the at least one parameter and/or a product of the difference and a third parameter of the at least one parameter; or updating the at least a part of the quantized latent representation by at least adding a fourth parameter of the at least one parameter.

Clause 4. The method of any of clauses 2-3, wherein the prediction is a mean, or the difference is comprised in a quantized residual latent representation of the visual data.

Clause 5. The method of any of clauses 2-4, wherein obtaining the at least a part of the quantized latent representation comprises: performing an entropy decoding process on the bitstream to obtain the at least a part of the quantized latent representation.

Clause 6. The method of clause 5, further comprises: generating the prediction by using a first model.

Clause 7. The method of any of clauses 2-4, wherein obtaining the at least a part of the quantized latent representation comprises: obtaining the difference by performing an entropy decoding process on the bitstream; generating the prediction by using a first model; and generating the at least a part of the quantized latent representation based on the prediction and the difference.

Clause 8. The method of any of clauses 6-7, wherein generating the prediction comprises: generating a prediction of a sample in the at least a part of the quantized latent representation based on at least one reconstructed sample of the quantized latent representation by using the first model.

Clause 9. The method of any of clauses 6-8, wherein the first model is a prediction model.

Clause 10. The method of any of clauses 6-9, wherein the first model is autoregressive.

Clause 11. The method of any of clauses 6-10, wherein the first model comprises a context subnetwork or a context model subnetwork.

Clause 12. The method of any of clauses 2-11, wherein the at least a part of the quantized latent representation comprises all samples of the quantized latent representation, and the intermediate representation corresponds to a result of the updating.

Clause 13. The method of any of clauses 2-11, further comprising: updating a further part of the quantized latent representation based on at least one further parameter different from the at least one parameter, the further part being different from the at least a part of the quantized latent representation.

Clause 14. The method of clause 1, wherein obtaining the intermediate representation comprises: generating at least a part of the intermediate representation based on the prediction and the difference.

Clause 15. The method of clause 14, wherein generating the at least a part of the intermediate representation comprises: generating the at least a part of the intermediate representation by adding up: a product of the prediction and a first parameter of the at least one parameter, and a product of the difference and a second parameter of the at least one parameter, or generating the at least a part of the intermediate representation by adding up: the product of the prediction and the first parameter, the product of the difference and the second parameter, and a third parameter of the at least one parameter.

Clause 16. The method of any of clauses 14-15, wherein at least one of the prediction or the difference is generated by using a first model.

Clause 17. The method of any of clauses 6-8 and 16, wherein the first model is an estimation model.

Clause 18. The method of any of clauses 6-8 and 16-17, wherein the first model comprises a neural network-based subnetwork, or an input of the first model comprises the bitstream.

Clause 19. The method of any of clauses 6-8 and 16-17, wherein the first model comprises a first subnetwork for generating the prediction and a second subnetwork for generating a statistical value.

Clause 20. The method of clause 19, wherein the first subnetwork is a hyper decoder subnetwork, and the second subnetwork is a hyper scale decoder subnetwork.

Clause 21. The method of any of clauses 1-20, further comprising: determining the at least a part of the quantized latent representation from the quantized latent representation.

Clause 22. The method of clause 21, wherein determining the at least a part of the quantized latent representation from the quantized latent representation comprises: determining whether the at least a part of the quantized latent representation comprises a sample of the quantized latent representation based on at least one of the following: a comparison between a first threshold and a statistical value corresponding to the sample, a comparison between a second threshold and a value determined based on the statistical value, or a comparison between a third threshold and an index of the sample.

Clause 23. The method of clause 21, wherein determining the at least a part of the quantized latent representation from the quantized latent representation comprises: determining whether the at least a part of the quantized latent representation comprises samples in a block of the quantized latent representation based on at least one of the following: a comparison between a fourth threshold and a statistical value corresponding each of the samples, a comparison between a fifth threshold and a metric determined based on statistical values corresponding the samples, or a comparison between a sixth threshold and an index of each of the samples.

Clause 24. The method of clause 23, wherein the metric is an average, a minimum or a maximum.

Clause 25. The method of any of clauses 22-24, wherein an index of a sample indicates one of the following: a channel number of the sample, a feature map identifier of the sample, or a spatial coordinate of the sample.

Clause 26. The method of any of clauses 22-25, wherein at least one of the following thresholds or an indication of at least one of the following is indicated in the bitstream: the first threshold, the second threshold, the third threshold, the fourth threshold, the fifth threshold, or the sixth threshold.

Clause 27. The method of any of clauses 19-26, wherein the statistical value is a variance.

Clause 28. The method of any of clauses 19-27, wherein the statistical value is a variance of a gaussian probability, or the statistical value is obtained based on the bitstream by using the second subnetwork.

Clause 29. The method of any of clauses 1-28, wherein the at least one parameter or an indication of the at least one parameter is comprised in the bitstream.

Clause 30. The method of any of clauses 1-29, wherein the at least one parameter is a scalar value different from zero or a vector.

Clause 31. The method of any of clauses 1-30, wherein the at least one parameter is determined based on a quality metric.

Clause 32. The method of clause 31, wherein the quality metric comprises at least one of the following: a mean squared error, a structural similarity (SSIM), or a multiscale structure similarity (MS-SSIM).

Clause 33. The method of any of clauses 1-32, wherein the at least a part of the quantized latent representation comprises one or more samples of the quantized latent representation.

Clause 34. The method of any of clauses 1-33, wherein the synthesis transform is performed by using a neural network-based subnetwork, or the first neural network is used to perform an analysis transform on the visual data.

Clause 35. The method of any of clauses 1-34, wherein at least one of the following is indicated the bitstream: information on whether to apply the method, or information on how to apply the method.

Clause 36. The method of any of clauses 1-34, wherein at least one of the following is dependent on a color format and/or a color component of the visual data: information on whether to apply the method, or information on how to apply the method.

Clause 37. The method of any of clauses 1-36, wherein a value included in the bitstream is coded at one of the following: a sequence level, a picture level, a slice level, or a block level.

Clause 38. The method of any of clauses 1-37, wherein a value included in the bitstream is binarized before being coded.

Clause 39. The method of any of clauses 1-38, wherein a value included in the bitstream is coded with at least one arithmetic coding context.

Clause 40. The method of any of clauses 1-39, wherein the visual data comprise a picture of a video or an image.

Clause 41. The method of any of clauses 1-40, wherein the conversion includes encoding the visual data into the bitstream.

Clause 42. The method of any of clauses 1-40, wherein the conversion includes decoding the visual data from the bitstream.

Clause 43. An apparatus for visual data processing comprising a processor and a non-transitory memory with instructions thereon, wherein the instructions upon execution by the processor, cause the processor to perform a method in accordance with any of clauses 1-42.

Clause 44. A non-transitory computer-readable storage medium storing instructions that cause a processor to perform a method in accordance with any of clauses 1-42.

Clause 45. A non-transitory computer-readable recording medium storing a bitstream of visual data which is generated by a method performed by an apparatus for visual data processing, wherein the method comprises: obtaining an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; and generating the bitstream based on a synthesis transform on the intermediate representation, wherein the quantized latent representation is generated based on applying a first neural network to the visual data.

Clause 46. A method for storing a bitstream of visual data, comprising: obtaining an intermediate representation of the visual data, the intermediate representation being different from a quantized latent representation of the visual data and being generated based on at least one of the following: at least one parameter, at least a part of the quantized latent representation, a prediction of the at least a part of the quantized latent representation, or a difference between the prediction and the at least a part of the quantized latent representation; generating the bitstream based on a synthesis transform on the intermediate representation; and storing the bitstream in a non-transitory computer-readable recording medium, wherein the quantized latent representation is generated based on applying a first neural network to the visual data.

### Example Device

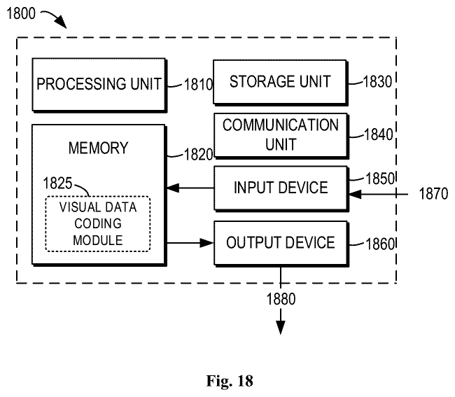

FIG. 18 illustrates a block diagram of a computing device 1800 in which various embodiments of the present disclosure can be implemented. The computing device 1800 may be implemented as or included in the source device 110 (or the visual data encoder 114) or the destination device 120 (or the visual data decoder 124).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof.

The storage unit 1830 may be any detachable or non-detachable medium and may include a machine-readable medium such as a memory, flash memory drive, magnetic disk or another other media, which can be used for storing information and/or visual data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement visual data encoding/decoding in embodiments of the present disclosure. The memory 1820 may include one or more visual data coding modules 1825 having one or more program instructions. These modules are accessible and executable by the processing unit 1810 to perform the functionalities of the various embodiments described herein.

In the example embodiments of performing visual data encoding, the input device 1850 may receive visual data as an input 1870 to be encoded. The visual data may be processed, for example, by the visual data coding module 1825, to generate an encoded bitstream. The encoded bitstream may be provided via the output device 1860 as an output 1880.

In the example embodiments of performing visual data decoding, the input device 1850 may receive an encoded bitstream as the input 1870. The encoded bitstream may be processed, for example, by the visual data coding module 1825, to generate decoded visual data. The decoded visual data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data with a neural network (NN)-based model, an intermediate representation of the visual data, the intermediate representation being different from a quantized latent representation of the visual data and being generated based on at least one of the following:
at least one parameter,
at least a part of the quantized latent representation,
a prediction of the at least a part of the quantized latent representation, or
a difference between the prediction and the at least a part of the quantized latent representation; and
performing, for the conversion, a synthesis transform on the intermediate representation.

2. The method of claim 1, wherein obtaining the intermediate representation comprises:
obtaining the at least a part of the quantized latent representation; and
updating the at least a part of the quantized latent representation based on at least one of the at least one parameter, the prediction or the difference, to obtain at least a part of the intermediate representation.

3. The method of claim 2, wherein updating the at least a part of the quantized latent representation comprises at least one of:
scaling the at least a part of the quantized latent representation with a first parameter of the at least one parameter;
updating the at least a part of the quantized latent representation based on a product of the prediction and a second parameter of the at least one parameter and/or a product of the difference and a third parameter of the at least one parameter; or
updating the at least a part of the quantized latent representation by at least adding a fourth parameter of the at least one parameter, or
wherein the prediction is a mean, or the difference is comprised in a quantized residual latent representation of the visual data, or
wherein obtaining the at least a part of the quantized latent representation comprises: performing an entropy decoding process on the bitstream to obtain the at least a part of the quantized latent representation.

4. The method of claim 2, wherein obtaining the at least a part of the quantized latent representation comprises:
obtaining the difference by performing an entropy decoding process on the bitstream;
generating the prediction by using a first model in the NN-based model; and
generating the at least a part of the quantized latent representation based on the prediction and the difference.

5. The method of claim 4, wherein generating the prediction comprises: generating a prediction of a sample in the at least a part of the quantized latent representation based on at least one reconstructed sample of the quantized latent representation by using the first model, or
wherein the first model is a prediction model, or
wherein the first model is autoregressive, or
wherein the first model comprises a context subnetwork or a context model subnetwork.

6. The method of claim 2, wherein the at least a part of the quantized latent representation comprises all samples of the quantized latent representation, and the intermediate representation corresponds to a result of the updating, or
wherein the method further comprises: updating a further part of the quantized latent representation based on at least one further parameter different from the at least one parameter, the further part being different from the at least a part of the quantized latent representation.

7. The method of claim 1, wherein obtaining the intermediate representation comprises:
generating at least a part of the intermediate representation based on the prediction and the difference.

8. The method of claim 7, wherein generating the at least a part of the intermediate representation comprises:
generating the at least a part of the intermediate representation by adding up:
a product of the prediction and a first parameter of the at least one parameter, and
a product of the difference and a second parameter of the at least one parameter, or generating the at least a part of the intermediate representation by adding up:
the product of the prediction and the first parameter,
the product of the difference and the second parameter, and
a third parameter of the at least one parameter, or
wherein at least one of the prediction or the difference is generated by using a first model.

9. The method of claim 4, wherein the first model comprises a neural network-based subnetwork, or an input of the first model comprises the bitstream, or
wherein the first model comprises at least one of a first subnetwork for generating the prediction or a second subnetwork for generating a statistical value.

10. The method of claim 9, wherein the first subnetwork is a hyper decoder subnetwork, the second subnetwork is a hyper scale decoder subnetwork, or the statistical value is a variance.

11. The method of claim 1, further comprising:
determining the at least a part of the quantized latent representation from the quantized latent representation.

12. The method of claim 11, wherein determining the at least a part of the quantized latent representation from the quantized latent representation comprises:
determining whether the at least a part of the quantized latent representation comprises a sample of the quantized latent representation based on at least one of the following:
a comparison between a first threshold and a statistical value corresponding to the sample,
a comparison between a second threshold and a value determined based on the statistical value, or
a comparison between a third threshold and an index of the sample, or
wherein determining the at least a part of the quantized latent representation from the quantized latent representation comprises:
determining whether the at least a part of the quantized latent representation comprises samples in a block of the quantized latent representation based on at least one of the following:
a comparison between a fourth threshold and a statistical value corresponding each of the samples,
a comparison between a fifth threshold and a metric determined based on statistical values corresponding the samples, or
a comparison between a sixth threshold and an index of each of the samples.

13. The method of claim 12, wherein the metric is an average, a minimum or a maximum, or
wherein an index of a sample indicates one of the following: a channel number of the sample, a feature map identifier of the sample, or a spatial coordinate of the sample, or
wherein at least one of the following thresholds or an indication of at least one of the following is indicated in the bitstream: the first threshold, the second threshold, the third threshold, the fourth threshold, the fifth threshold, or the sixth threshold.

14. The method of claim 1, wherein the at least one parameter or an indication of the at least one parameter is comprised in the bitstream, or
wherein the at least one parameter is a scalar value different from zero or a vector, or
wherein the at least one parameter is determined based on a quality metric, or
wherein the at least a part of the quantized latent representation comprises one or more samples of the quantized latent representation.

15. The method of claim 1, wherein at least one of the following is indicated in the bitstream: information on whether to apply the method, or information on how to apply the method, or
wherein at least one of the following is dependent on a color format and/or a color component of the visual data: information on whether to apply the method, or information on how to apply the method, or
wherein a value included in the bitstream is coded at one of the following: a sequence level, a picture level, a slice level, or a block level, or
wherein a value included in the bitstream is binarized before being coded, or
wherein a value included in the bitstream is coded with at least one arithmetic coding context, or
wherein the visual data comprise a picture of a video or an image.

16. The method of claim 1, wherein the quantized latent representation is generated based on applying a first neural network in the NN-based model to the visual data.

17. The method of claim 1, wherein the conversion includes encoding the visual data into the bitstream, or
wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
obtaining, for a conversion between visual data and a bitstream of the visual data with a neural network (NN)-based model, an intermediate representation of the visual data, the intermediate representation being different from a quantized latent representation of the visual data and being generated based on at least one of the following:
at least one parameter,
at least a part of the quantized latent representation,
a prediction of the at least a part of the quantized latent representation, or
a difference between the prediction and the at least a part of the quantized latent representation; and
performing, for the conversion, a synthesis transform on the intermediate representation.

19. A non-transitory computer-readable storage medium storing instructions that cause a processor to perform acts comprising:
obtaining, for a conversion between visual data and a bitstream of the visual data with a neural network (NN)-based model, an intermediate representation of the visual data, the intermediate representation being different from a quantized latent representation of the visual data and being generated based on at least one of the following:
at least one parameter,
at least a part of the quantized latent representation,
a prediction of the at least a part of the quantized latent representation, or
a difference between the prediction and the at least a part of the quantized latent representation; and
performing, for the conversion, a synthesis transform on the intermediate representation.

20. A non-transitory computer-readable recording medium storing a bitstream of visual data which is generated by a method performed by an apparatus for visual data processing, wherein the method comprises:
obtaining an intermediate representation of the visual data, the intermediate representation being different from a quantized latent representation of the visual data and being generated based on at least one of the following:
at least one parameter,
at least a part of the quantized latent representation,
a prediction of the at least a part of the quantized latent representation, or
a difference between the prediction and the at least a part of the quantized latent representation; and
generating the bitstream with a neural network (NN)-based model based on a synthesis transform on the intermediate representation.
